(19) United States
(12) Patent Application Publication
(10) Pub. No.: US 2025/0190582 A1
(43) Pub. Date: Jun. 12, 2025

(54) INFORMATION PROCESSING APPARATUS, METHOD, AND COMPUTER READABLE MEDIUM

(71) Applicant: NEC Corporation, Minato-ku, Tokyo (JP)

(72) Inventors: Ryo MIZUSHIMA, Tokyo (JP); Tomohiko YAGYU, Tokyo (JP)

(73) Assignee: NEC Corporation, Minato-ku, Tokyo (JP)

(21) Appl. No.: 18/843,806

(22) PCT Filed: Mar. 18, 2022
(86) PCT No.: PCT/JP2022/012547

§ 371 Date: Sep. 4, 2024

(51) Int. Cl. G06F 21/57

(52) U.S. Cl. CPC G06F 21/577; G06F 2221/034

(57) ABSTRACT

Analysis result acquisition means acquires a result of a risk analysis for a system to be analyzed. The result of the risk analysis includes attack routes. A measure information table includes an index indicating an effect of a measure introduced against an attack. Measure calculation means plans a measure against an attack used in an attack route by using the measure information table. Table update means updates the index indicating the effect included in the measure information table based on the planned measure and measure related information.

### TECHNICAL FIELD

The present disclosure relates to an information processing apparatus, a method, and a computer readable medium.

### BACKGROUND ART

In recent years, threats of cyber-attacks have not been limited to the fields of Information and Communication Technology (ICT), and damages have also been occurring in the fields of control systems and Internet of Things (IoT). In the case of control systems, in particular, there have been cases where the operation of a critical infrastructure has been jeopardized, such as a case where a power system or a factory is shut down. To cope with such threats of cyber-attacks, it is important to clarify security risks present in a system, implement measures thereagainst, and thereby reduce the risks.

As a related art, Patent Literature 1 discloses an information processing apparatus for supporting the implementation of security measures in a data system. The information processing apparatus disclosed in Patent Literature 1 specifies threats which should be dealt with in the data system, and extracts a security measure against each of the specified threats. The information processing apparatus combines the extracted security measures and thereby generates combination patterns of security measures for the specified threats. The information processing apparatus calculates, for each of such combination patterns, an implementation effect value on the data system under the assumption that the combination pattern is implemented, and selects a specific combination pattern based on the calculated effect values.

### CITATION LIST

### Patent Literature

Patent Literature 1: Japanese Unexamined Patent Application Publication No. 2015-130152

### SUMMARY OF INVENTION

### Technical Problem

However, in Patent Literature 1, a security measure to be implemented is determined according to the implementation effect value, and the planned measure cannot always be adopted as it is in the data system. For example, the security measure having the lowest implementation effect value is not necessarily the best security measure, and a security measure different from the security measure to be implemented or security measure desired to be implemented may be planned.

In view of the above-described circumstances, an object of the present disclosure is to provide an information processing apparatus, a method, and a computer readable medium capable of appropriately planning a measure introduced into a system.

### Solution to Problem

To achieve the above-described object, as a first aspect, the present disclosure provides an information processing apparatus. An information processing apparatus includes: analysis result acquisition means for acquiring a result of a risk analysis on a system to be analyzed, including an attack route; measure calculation means for planning a measure against an attack used in the attack route by using a measure information table including an index indicating an effect of the measure introduced against the attack; and table update means for updating the index indicating the effect included in the measure information table based on the planned measure and measure related information.

As a second aspect, the present disclosure provides an information processing method. An information processing method includes: acquiring a result of a risk analysis on a system to be analyzed, including an attack route; planning a measure against an attack used in the attack route by using a measure information table including an index indicating an effect of the measure introduced against the attack; and updating the index indicating the effect included in the measure information table based on the planned measure and measure related information.

As a third aspect, the present disclosure provides a computer readable medium. A computer readable medium stores a program for causing a computer to perform processes including: acquiring a result of a risk analysis on a system to be analyzed, including an attack route; planning a measure against an attack used in the attack route by using a measure information table including an index indicating an effect of the measure introduced against the attack; and updating the index indicating the effect included in the measure information table based on the planned measure and measure related information.

### Advantageous Effects of Invention

The information processing apparatus, the method, and the computer readable medium according to the present disclosure can appropriately plan a measure introduced into the system.

### BRIEF DESCRIPTION OF DRAWINGS

FIG. 1 is a block diagram showing a schematic configuration of an information processing apparatus.

FIG. 2 is a block diagram showing an information processing apparatus according to a first example embodiment of the present disclosure.

FIG. 3 shows an example of an update of a measure candidate table.

FIG. 4 shows a map used to determine risk values.

FIG. 5 shows an example of displayed risk values of attack routes including effects of measures.

FIG. 6 is a flowchart showing an operating procedure performed by the information processing apparatus.

FIG. 7 is a block diagram showing an information processing apparatus according to a second example embodiment of the present disclosure.

FIG. 8 is a block diagram showing an example of a configuration of a table generation unit.

FIG. 9 shows an example of a table update in generation of a measure compatibility table.

FIG. 10 shows an example of an update of the measure compatibility table.

FIG. 11 is a flowchart showing an operating procedure performed by the information processing apparatus according to the second example embodiment.

FIG. 12 is a block diagram showing an information processing apparatus according to a third example embodiment of the present disclosure.

FIG. 13 shows an example of modification information recorded in measure related information.

FIG. 14 shows an example of a table used to update a measure compatibility table.

FIG. 15 shows an example of an update of the measure compatibility table.

FIG. 16 is a flowchart showing an operating procedure performed by a table update unit according to the third example embodiment.

FIG. 17 shows another example of the measure compatibility table.

FIG. 18 is a block diagram showing an example of a configuration of a computer apparatus.

### EXAMPLE EMBODIMENT

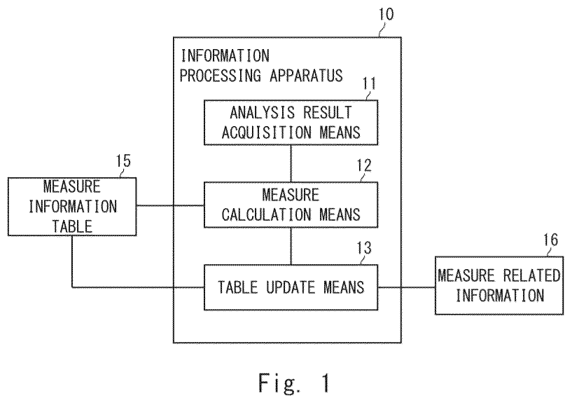

Prior to describing an example embodiment according to the present disclosure, an outline of the present disclosure will be described. FIG. 1 shows a schematic configuration of an information processing apparatus. An information processing apparatus 10 includes analysis result acquisition means 11, measure calculation means 12, and table update means 13. The information processing apparatus 10 can function as an apparatus that supports planning of security measures.

The analysis result acquisition means 11 acquires a result of a risk analysis on a system to be analyzed. The result of the risk analysis includes attack routes. The measure calculation means 12 plans measures against attacks used in the attack routes included in the result of the risk analysis by using a measure information table 15. The measure information table 15 includes an index indicating an effect of a measure introduced against an attack. The table update means 13 updates the index indicating the effect included in the measure information table based on the measure planned by the measure calculation means 12 and predetermined measure related information 16.

In the present disclosure, the table update means 13 updates the measure information table 15 used to plan the measure in the measure calculation means 12 by using the measure related information 16. In a case where the table update means 13 updates the measure information table 15, the measure planned by the measure calculation means 12 can change before and after the update. In the present disclosure, it is possible to appropriately plan a measure to be introduced into the system by learning the measure information table 15 using the appropriate measure related information 16.

An example embodiment according to the present disclosure will be described hereinafter in detail. Note that in the description and drawings to be described below, omission and simplification are made as appropriate, for clarity of description. Further, the same elements and similar elements are denoted by the same reference symbols throughout the drawings, and redundant descriptions are omitted as necessary.

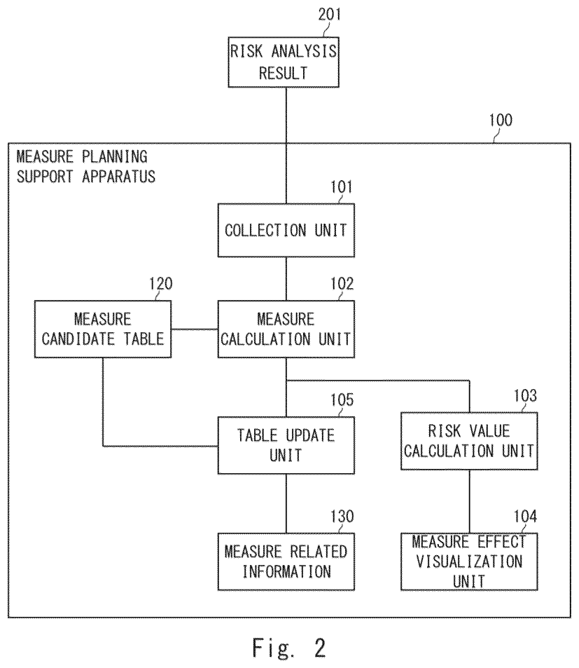

FIG. 2 shows an information processing apparatus according to a first example embodiment of the present disclosure. In this example embodiment, the information processing apparatus may also be called a measure planning support apparatus. A measure planning support apparatus 100 includes a collection unit 101, a measure calculation unit 102, a risk value calculation unit 103, a measure effect visualization unit 104, and a table update unit 105. The measure planning support apparatus 100 includes, for example, at least one memory and at least one processor. At least some of the functions of the various units in the measure planning support apparatus 100 can be implemented by a processor operating according to a program read from the memory.

A risk analysis result 201 of a system of which the risk is analyzed is input to the measure planning support apparatus 100. The collection unit 101 acquires the risk analysis result 201. The risk analysis result 201 includes attack routes. Note that the “attack route” refers to, for example, a route that an attacker follows when he/she attacks the final attack target by using a certain asset as an entry point. The attack route is also called an attack tree. Further, the “attack” also refers to, for example, an operation that is maliciously carried out on such an asset. Examples of the attack include “data tampering”, an “unauthorized operation”, and a “Denial-of-Service (DoS) attack”. The attack route includes at least one attack step. Each attack step includes an attack source, an attack target, and an attack. The risk analysis is performed by, for example, creating a virtual model from information about the configuration of the real environment, generating attack routes according to attack scenarios to be analyzed, and calculating a risk for each of the attack routes. The risk analysis may be performed manually or by using a risk analyzer. The collection unit 101 corresponds to the analysis result acquisition means 11 shown in FIG. 1.

A measure candidate table 120 is a table containing a plurality of measures (candidates thereof) that can be introduced against attacks and indices indicating the effects of the respective measures. Note that the “measure” indicates a security measure for preventing an attack or reducing damage caused by an attack. The measure candidate table 120 holds, for example, “Attack means against which measure is effective”, “Effect”, and “Priority” for each of a plurality of measures. “Attack means against which measure is effective” indicates against which attack the measure is introduced. “Effect” and “Priority” are indices indicating the effect of the measure when the measure is introduced. “Effect” indicates the magnitude of the effect of the measure when the measure is introduced. “Priority” is set according to the effect of the measure and the cost of the implementation thereof when the measure is introduced. For example, for a given measure, “Priority” is set to a value smaller than that of “Effect” when the effect of the measure is large but the cost of the implementation thereof is high. Each of “Effect” and “Priority” is represented by, for example, a real number between 0 and 1 (inclusive). In this example embodiment, the measure candidate table 120 corresponds to a table included in the measure information table 15 shown in FIG. 1.

The measure calculation unit 102 plans measures against attacks used in attack routes included in the risk analysis result 201 by using the measure candidate table 120. The planned measures may include two or more measures. Regarding the planning of measures, the measure calculation unit 102 selects at least one measure based on the indices indicating the effects of measures contained in the measure candidate table 120. In the following description, it is assumed that the measure calculation unit 102 uses the priority as an index indicating the effect. For example, the measure calculation unit 102 selects, in the measure candidate table 120, a measure in descending order of priority among measures effective against the attack means used in the attack. The measure calculation unit 102 plans a measure against an attack used in each attack route for each of the plurality of attack routes included in the risk analysis result 201. The measure calculation unit 102 corresponds to the measure calculation means 12 shown in FIG. 1.

The table update unit 105 updates the indices indicating the effects of the measures contained in the measure candidate table 120 based on the measure planned by the measure calculation unit 102 and measure related information 130. The measure related information 130 includes, for example, at least one of a measure policy for constructing a robust system, a measure policy according to a predetermined security policy, and a measure policy for using a specific measure product. The measure policy according to the security policy may include, for example, information such as applying a patch and applying communication restriction. The measure policy for using a specific measure product may include, when a security product to be used is determined, a name of the product, and the like. For example, the measure related information may include a product name (merchandise information) of a security product that has been promoted for sale.

The measure related information 130 may include information for planning a general-purpose recommended measure in a general information system. The measure related information 130 may include, for example, information about a threat (attack means) that can be dealt with by each measure. In addition, the measure related information 130 may include a list of vulnerabilities that can be dealt with by each measure. The measure related information 130 may include type information of a measure, such as an anti-virus, an intrusion prevention system (IPS), or unified threat management (UTM). The measure related information 130 may include a table of bugs found in the system and failure information provided by a vendor. The measure related information 130 may include information about measures implemented in the past. The measure related information 130 may include information such as a price of a product and a product that is discounted when purchased simultaneously. When the measure is introduction of a hardware product, the measure related information 130 may include information about a physical size of the product. The measure related information 130 corresponds to the measure related information 16 shown in FIG. 1.

For example, the table update unit 105 compares a measure planned according to the measure related information 130 with a measure planned by the measure calculation unit 102. In the following description, the measure planned according to the measure related information 130 is also called as a recommended measure plan. The recommended measure plan can also be called a measure plan serving as a reference (reference measure plan) or ground truth data of measure planning. The table update unit 105 updates the measure candidate table 120 based on the comparison result. For example, the table update unit 105 updates the measure candidate table 120 in a case where the recommended measure plan is different from the measure planned by the measure calculation unit 102. In this example embodiment, the table update unit 105 updates the priority of the measure candidate table 120.

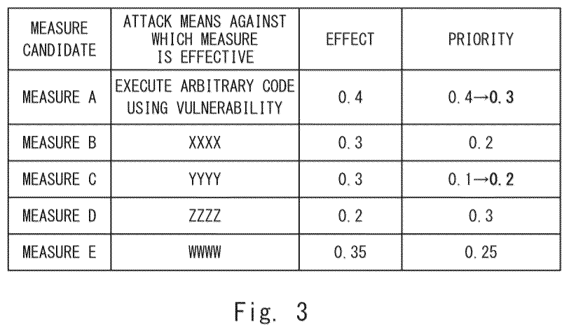

FIG. 3 shows an example of the update of the measure candidate table 120. For example, it is assumed that the measure planned by the measure calculation unit 102 is a measure A. In addition, it is assumed that the recommended measure plan planned using the measure related information 130 is a measure C. In this case, the table update unit 105 increases the priority of the measure C included in the recommended measure plan from 0.1 to 0.2. In addition, the table update unit 105 decreases the priority of the measure A from 0.4 to 0.3. In a case where the table update unit 105 updates the priority of the measure candidate table 120, a possibility that the measure A is selected by the measure calculation unit 102 decreases and a possibility that the measure C is selected increases in the next measure planning.

In the measure planning support apparatus 100, the measure calculation unit 102 may plan a measure for each of a plurality of risk analysis results 201 sequentially input, and the table update unit 105 may sequentially update the measure candidate table 120 by using the plurality of planned measures. Alternatively, the measure planning support apparatus 100 may repeatedly perform the planning of a measure by the measure calculation unit 102 and the update of the measure candidate table 120 by the table update unit 105 for one risk analysis result 201. The table update unit 105 corresponds to the table update means 13 shown in FIG. 1.

The risk value calculation unit (risk value calculation means) 103 calculates the risk value of the attack route under the assumption that the measure(s) planned by the measure calculation unit 102 are introduced into the system to be analyzed. The risk value indicates the degree of damage that the attack inflicts on the system. For example, the risk value calculation unit 103 acquires the priority of the measure from the measure candidate table 120 and calculates the risk value based on the acquired priority.

An example of calculation of the risk value will be described. The risk value calculation unit 103 calculates a risk value for each of attack steps included in the attack route. As an example, the risk value calculation unit 103 calculates the risk value based on a business damage level, a threat level, and a vulnerability level of the attack step. The business damage level and the threat level may be included in, for example, the risk analysis result 201. Assume that each of the business damage level and the threat level has, for example, three levels from Level 1 to Level 3. The risk value calculation unit 103 determines the risk value, for example, according to a combination of the business damage level with the product of the threat level and the vulnerability level.

The risk value calculation unit 103 acquires the effect of a measure for each attack step. Here, it is assumed that the priority included in the measure candidate table 120 is used as the effect of a measure for each attack step. For example, the risk value calculation unit 103 converts the effect of a measure for each attack step into the vulnerability level according to the value thereof. In this example, it is assumed that the vulnerability level has three levels from Level 1 to Level 3. The risk value calculation unit 103 sets the vulnerability level to Level 1 when, for example, the effect (priority) of the measure is 0.8 or higher. The risk value calculation unit 103 sets the vulnerability level to Level 2 when the effect of the measure is 0.5 or higher and lower than 0.8. The risk value calculation unit 103 sets the vulnerability level to Level 3 when the effect of the measure is lower than 0.5.

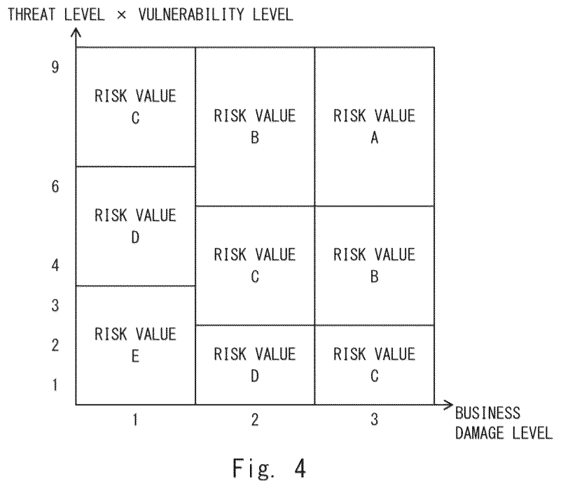

FIG. 4 shows a map used to determine a risk value. In FIG. 4, the horizontal axis indicates the business damage level, and the vertical axis indicates the product of the threat level and the vulnerability level. Assume that a risk value A represents the highest risk and a risk value E represents the lowest risk. The risk value calculation unit 103 calculates the risk value of each attack step by using, for example, the map shown in FIG. 4. Assume that, for example, for the attack step from a host A to a host B, the vulnerability level is Level 1; the threat level is Level 3; and the business damage level is Level 2. In that case, the risk value calculation unit 103 determines that the risk value of the attack step from the host A to the host B is a risk value C.

The risk value calculation unit 103 determines the risk value of the attack route from the calculated risk values for the respective attack steps. The risk value calculation unit 103 determines, for example, the risk value of the lowest risk among the risk values of the attack steps included in the attack route as the risk value of the attack route. This is because, in order to establish the attack route, the attacker needs to succeed in the attack step having the lowest risk value, in other words, needs to succeed in the most difficult attack. The method for determining a risk value is not particularly limited to the above-described method, and the risk value calculation unit 103 may determine a risk value by using a method different from the above-described method.

The measure effect visualization unit (measure effect visualization means) 104 displays the measure planned by the measure calculation unit 102 on a display screen of a display device (not shown), and presents the planned measure to a user. Further, the measure effect visualization unit 104 displays the risks of attack routes including effects of measures on the display screen of the display device. The measure effect visualization unit 104 presents the risks of attack routes to the user in a table format including not only the risk values but also the effects of the measures.

For example, the measure effect visualization unit 104 calculates an effect of a measure under the assumption that the planned measure is introduced, for each attack route. For example, the measure effect visualization unit 104 calculates, as the effect of the measure, the sum total of the priorities of the measures included in the planned measure. Alternatively, the measure effect visualization unit 104 calculates, as the effect of the measure, the sum total of the measures included in the planned measure. The measure effect visualization unit 104 displays the calculated effect of the measure in association with the risk value of the attack route. For example, the measure effect visualization unit 104 may divide the effect of the measure into a plurality of sections and display the number of attack routes corresponding to the section of the effect of the measure and the risk value in a table format.

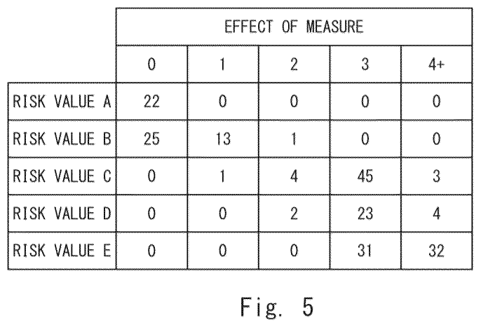

FIG. 5 shows an example of displayed risk values of attack routes including effects of measures. The measure effect visualization unit 104 calculates the total value of effects (priorities) of measures for each attack route. For example, the measure effect visualization unit 104 rounds down the fractional portion of the total value of effects of measures, and thereby converts it into an integer. The measure effect visualization unit 104 divides the effects of the measures into five sections of 0, 1, 2, 3, and 4 or greater (4+). The measure effect visualization unit 104 counts, for each combination of a section (an integer value) of the effect of the measure and a risk value, the number of attack routes for that combination. The measure effect visualization unit 104 displays the counted numbers of attack routes in a table format as shown in FIG. 5.

The measure effect visualization unit 104 may calculate the number of measures introduced in the attack route, instead of calculating the total value of effects of measures in the attack route. In that case, for example, the measure effect visualization unit 104 may divide, for example, the numbers of measures into a plurality of sections such as a section from 0 or greater to less than 2, a section from 2 or greater to less than 4, and a section of 4 or greater, and display the number of attack routes for each risk value and for each section in a table format.

A user who plans security measures can recognize a distribution of risk values of attack routes by referring to the table shown in FIG. 5. Further, the user can recognize the number of attack routes for each risk value and for each effect of a measure. By referring to the table shown in FIG. 5, the user can recognize, for example, for high-risk attack routes, the number of attack routes in which an effective measure(s) is introduced and the number of attack routes in which no effective measure has been introduced. Further, the user can recognize how many attack routes of which risks are high but in which no measure has been introduced or the introduced measure is not sufficiently effective are present.

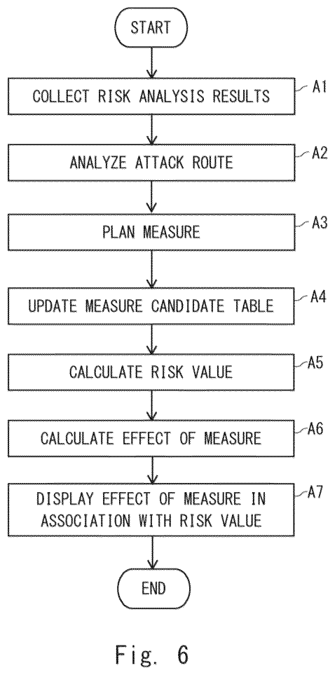

Next, an operating procedure will be described. FIG. 6 shows an operating procedure (information processing method) performed by the measure planning support apparatus 100. The collection unit 101 acquires the risk analysis result 201 (step A1). The measure calculation unit 102 analyzes an attack route and specifies a vulnerability or the like used in an attack step (step A2). The measure calculation unit 102 plans a measure against the attack step (step A3). In the step A3, the measure calculation unit 102 refers to the measure candidate table 120 and plans an effective measure against the attack step included in the attack route based on the priority.

The table update unit 105 updates the measure candidate table 120 based on the measure planned in the step A3 and the measure related information 130 (step A4). In the step A4, the table update unit 105 generates a recommended measure plan by using, for example, the measure related information 130. The table update unit 105 compares the measure planned in the step A3 with the recommended measure plan. The table update unit 105 increases or decreases the value of the priority in the measure candidate table 120 based on the comparison result.

In a case where there are many threats that can be dealt with by a measure, the table update unit 105 may increase the priority of the measure. Alternatively, the table update unit 105 may increase the priority of a measure that can deal with a large number of vulnerabilities. The table update unit 105 may increase the priority of a specific type of measure. The table update unit 105 may increase the priority of a measure corresponding to a product that has been promoted for sale. The table update unit 105 may increase the priorities of measures implemented in the past. The table update unit 105 may decrease the priority of a measure included in the bug table or the failure information. Further, the table update unit 105 may decrease the priority of a measure that has a large physical size and requires a place to be placed.

The risk value calculation unit 103 calculates a risk value under the assumption that the measure planned in the step A3 is introduced into the system to be analyzed (step A5). The measure effect visualization unit 104 calculates the effects (priorities) of the measures included in the planned measure and a combination thereof for each attack route (step A6). In the step A6, the measure effect visualization unit 104 calculates, for example, the total value of the priorities for each attack route. The measure effect visualization unit 104 displays the calculated effect of the measure in association with the risk value of the attack route (step A7). In the step A7, for example, the measure calculation unit 102 divides the total value of the effects of the measures into a plurality of sections, and displays the number of attack routes corresponding to the section of the effect of the measure and the risk value in a table format.

Either the step A4 or the steps A5 to A7 may be performed first. Alternatively, the step A4 and the steps A5 to A7 may be performed in parallel. The update of the table in the step A4 is not necessarily performed every time a measure is planned by the measure calculation unit 102. The update of the table in the step A4 may be performed when the user instructs the update of the table.

In this example embodiment, the table update unit 105 updates the measure candidate table 120 by using the measure related information 130. For example, the table update unit 105 plans a correct measure by using the measure related information 130, and compares the correct measure plan with the measure planned by the measure calculation unit 102. The table update unit 105 updates the measure candidate table 120 based on the comparison result. In this way, even in a case where a security operator does not have specialized advanced security knowledge, it is possible to obtain the measure candidate table 120 that enables planning of an appropriate measure. For example, in a case where the measure related information 130 includes information indicating a policy of an exemplary security measure as described in a textbook, the measure calculation unit 102 can plan a measure in which the exemplary security measure is to be applied. Furthermore, in a case where the measure related information 130 includes information indicating a policy of a security measure reflecting an intention of the user, the measure calculation unit 102 can plan a measure according to the intention of the user. The measure planning support apparatus 100 according to this example embodiment can appropriately plan a measure to be introduced into the system by updating the measure candidate table 120 using the measure related information 130.

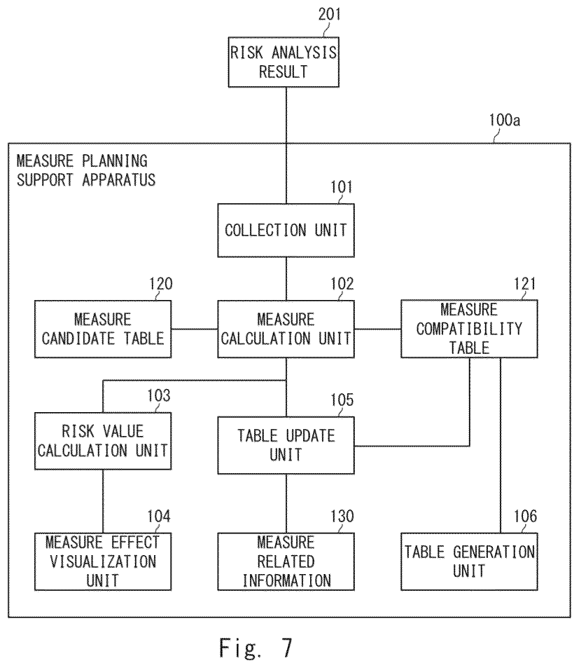

Next, a second example embodiment will be described. FIG. 7 shows an information processing apparatus according to the second example embodiment of the present disclosure. A configuration of an information processing apparatus (measure planning support apparatus) 100a according to this example embodiment includes a table generation unit 106 in addition to the components of the measure planning support apparatus 100 according to the first example embodiment shown in FIG. 2. In addition, in this example embodiment, a measure compatibility table 121 is used in addition to a measure candidate table 120.

The measure compatibility table 121 is a table containing combinations of measures in each of which two or more of a plurality of measures that can be introduced against attacks are combined with each other and indices indicating effects of the respective combinations of measures. The measure compatibility table 121 holds, for each combination of two or more measures which overlap one another or have limitations, information about, for example, whether they can be combined with each other, the effect of the combination, and a priority of the combination. In the measure compatibility table 121, “Effect” and “Priority” are indices indicating the effects of the combinations of measures when the combinations of measures are introduced. “Effect” indicates the magnitudes of the effects of the combinations of measures when the combinations of measures are introduced. “Priority” is set according to the effects of the combinations of measures and the cost of the implementation thereof when the combinations of measures are introduced. For combinations of measures that are not contained in the measure compatibility table 121, there are no overlap among the effects of measures and no limitation for the combinations. The measure compatibility table 121 corresponds to a table included in a measure information table 15 shown in FIG. 1.

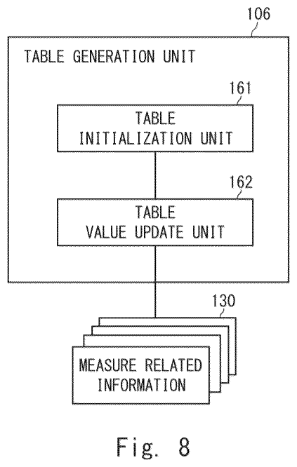

The table generation unit (table generation means) 106 generates the measure compatibility table 121 based on a plurality of pieces of measure related information 130 that have been input by using the plurality of pieces of measure related information 130 as inputs. FIG. 8 shows an example of a configuration of the table generation unit 106. The table generation unit 106 includes a table initialization unit 161 and a table value update unit 162. The table initialization unit (initialization means) 161 initializes the measure compatibility table 121. For example, the table initialization unit 161 initializes the effect and the priority included in the measure compatibility table 121.

The table value update unit (table value update means) 162 updates the initialized priority of the measure compatibility table 121. For example, the table value update unit 162 generates a measure (recommended measure plan) planned according to a measure policy included in the measure related information 130 for each piece of measure related information 130 to be input. The table value update unit 162 updates the priority in the measure compatibility table 121 according to whether or not the combination of measures contained in the measure compatibility table 121 is included in the recommended measure plan. For example, in a case where the combination of measures contained in the measure compatibility table 121 is included in the recommended measure plan, the table value update unit 162 increases the priority of the combination of measures.

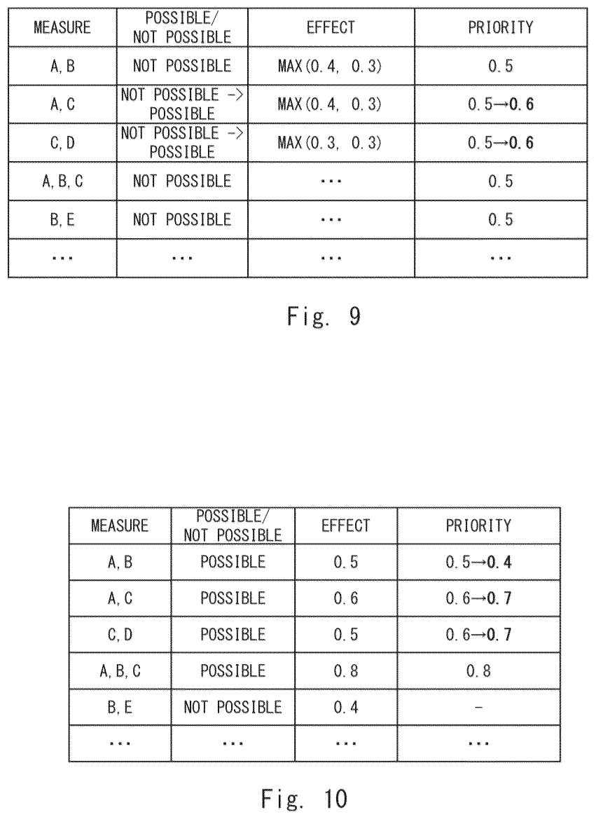

FIG. 9 shows an example of a table update in generation of the measure compatibility table 121. For example, the table initialization unit 161 initializes whether combinations are possible or not to “not possible” for each combination of measures. In addition, the table initialization unit 161 acquires a value of the effect of each combination of measures from the measure candidate table 120, and sets the maximum value thereof as an initial value of the effect. For example, for a combination of a measure A and a measure B, the table initialization unit 161 sets, as the initial value of the effect, a larger value “0.4” of the effect “0.4” of the measure A (see FIG. 3) and the effect “0.3” of the measure B. The table initialization unit 161 initializes the priority to a predetermined value, for example, “0.5” for all combinations of measures.

For example, it is assumed that the recommended measure plan generated based on certain measure related information 130 includes the measure A, a measure C, and a measure D. The table value update unit 162 changes a combination of measures including the measure A, the measure C, and the measure D from “not possible” to “possible”. In addition, the table value update unit 162 increases the priority of the combination of measures including the measure A, the measure C, and the measure D by a predetermined change amount, for example, 0.1. In the example shown in FIG. 9, the table value update unit 162 changes a combination of the measure A and the measure C from “not possible” to “possible”, and increases the priority from “0.5” to “0.6”. In addition, the table value update unit 162 changes a combination of the measure C and the measure D from “not possible” to “possible”, and increases the priority from “0.5” to “0.6”.

For example, in a case where a total of 100 pieces of measure related information 130 are used, the table value update unit 162 may divide the pieces of measure related information 130 into 10 sets of 10 pieces each, and repeatedly update the measure compatibility table 121 by using 10 pieces of measure related information 130 ten times. In this case, the table value update unit 162 may decrease an update amount (change amount) of the priority as the number of times increases.

When preparing the measure compatibility table 121, specialized security knowledge is required to determine the priority in the measure compatibility table 121. In this example embodiment, the table generation unit 106 updates the priority in the measure compatibility table 121 by using the plurality of pieces of measure related information 130. The table generation unit 106 updates the priority of each combination according to the recommended measure plan that is a correct answer, so that it is possible to generate the measure compatibility table 121 considered to be appropriate for planning of the measure even in a case where the user does not have specialized security knowledge.

In this example embodiment, the measure compatibility table 121 is not necessarily generated by the table generation unit 106. For example, the measure compatibility table 121 may be created outside the measure planning support apparatus 100a or may be created manually. In this case, the measure planning support apparatus 100a does not have to include the table generation unit 106.

Returning to FIG. 7, a measure calculation unit 102 plans measures against attacks used in attack routes included in a risk analysis result 201 by using the measure candidate table 120 and the measure compatibility table 121. Regarding the planning of measures, the measure calculation unit 102 plans a measure including a plurality of measures. In the planning of measures, the measure calculation unit 102 selects the first measure based on an index indicating an effect of a measure contained in the measure candidate table 120. In the following description, the measure calculation unit 102 refers to the priority as the index indicating an effect. For example, the measure calculation unit 102 selects, in the measure candidate table 120, a measure having the highest priority among measures effective against the attack step, as the first measure.

The measure calculation unit 102 selects a second measure and a measure subsequent thereto based on at least one of the priority included in the measure candidate table 120 and the priority included in the measure compatibility table 121. For example, in the selecting of the second measure and a measure subsequent thereto, the measure calculation unit 102 sequentially selects unselected measures among a plurality of measures effective against the attack step, and checks whether or not a combination of the selected measure with at least one measure already selected is contained in the measure compatibility table 121. When the combination is contained in the measure compatibility table 121, the measure calculation unit 102 uses the priority of the combination of measures contained in the measure compatibility table 121 as the priority of the selected measure when the combinations of measures are introduced. When the combination is not contained in the measure compatibility table 121, the measure calculation unit 102 uses the priority of the measure contained in the measure candidate table 120 as the priority of the selected measure when the combination is introduced. When the combination is “not possible” in the measure compatibility table 121, the measure calculation unit 102 does not include the selected measure in the planned measure.

In this example embodiment, a risk value calculation unit 103 calculates a risk value, for example, every time a measure is added to the measures planned by the measure calculation unit 102. In the calculation of the risk value, the risk value calculation unit 103 acquires the priority of the measure or a combination of measures from at least one of the measure candidate table 120 and the measure compatibility table 121. For example, the risk value calculation unit 103 acquires the priority from the measure compatibility table 121 for a combination of measures present in the measure compatibility table 121 among the measures included in the planned measure. The risk value calculation unit 103 acquires the priority from the measure candidate table 120 for a measure present in the measure compatibility table 121 among the measures included in the planned measure. The measure calculation unit 102 adds a measure until the risk value calculated by the risk value calculation unit 103 decreases beyond a predetermined criterion. When the risk value decreases beyond the predetermined criterion, the planning of the measure is finished.

In this example embodiment, a table update unit 105 compares a measure (recommended measure plan) planned according to the measure related information 130 with a measure planned by the measure calculation unit 102. The table update unit 105 updates the measure compatibility table 121 based on the comparison result. For example, the table update unit 105 increases or decreases the priority of the measure compatibility table 121 according to whether or not a combination of measures included in the measure planned by the measure calculation unit 102 is included in the recommended measure plan.

FIG. 10 shows an example of the update of the measure compatibility table 121. Here, it is assumed that the measure planned by the measure calculation unit 102 includes the measure A and the measure B. In addition, it is assumed that the recommended measure plan includes the measure A, the measure C, and the measure D. In this case, the table update unit 105 increases the priority of the combination of the measure A and the measure C that is not included in the measure planned by the measure calculation unit 102 but is included in the recommended measure plan from “0.6” by a predetermined change amount, for example, 0.1. In addition, the table update unit 105 increases the priority of the combination of the measure C and the measure D from “0.6” by 0.1. The table update unit 105 decreases the priority of a combination of the measure A and the measure B that is not included in the measure planned by the measure calculation unit 102 but is included in the recommended measure plan from “0.5” by a predetermined change amount, for example, 0.1.

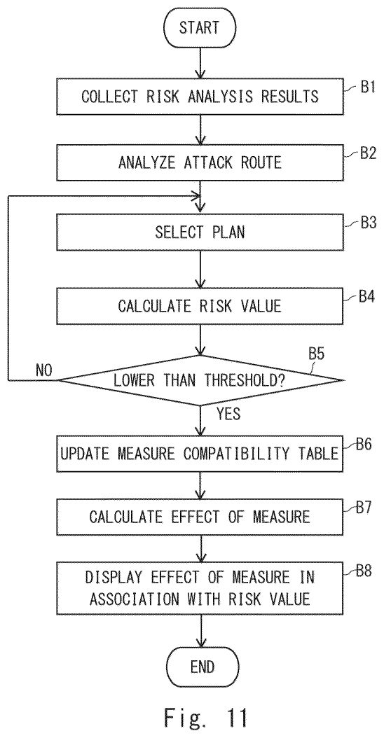

Next, an operating procedure will be described. FIG. 11 shows an operating procedure performed by the measure planning support apparatus 100a. A collection unit 101 acquires the risk analysis result 201 (step B1). The measure calculation unit 102 analyzes an attack route and specifies a vulnerability or the like used in an attack step (step B2). The measure calculation unit 102 selects a measure against the attack step (step B3). In the selecting of the first measure, the measure calculation unit 102 refers to the measure candidate table 120, and selects an effective measure against the attack step included in the attack route based on the priority.

The risk value calculation unit 103 calculates a risk value under the assumption that the measure selected in the step B3 is introduced into the system to be analyzed (step B4). The measure calculation unit 102 determines whether the risk value calculated in the step B4 is lower than a predetermined threshold (step B5). When the measure calculation unit 102 determines that the risk value is lower than the threshold in the step B5, it returns to the step B3 and selects an additional measure. In the adding of a second measure and the measure subsequent thereto, the measure calculation unit 102 selects an additional measure while giving consideration to the compatibility with the already selected measure by using the measure candidate table 120 and the measure compatibility table 121.

When the measure calculation unit 102 determines that the risk value is equal to or higher than the predetermined threshold in the step B5, it finishes the planning of measures. The table update unit 105 updates the measure compatibility table 121 based on the measure planned by the measure calculation unit 102 and the measure related information 130 (step B6). In the step B6, the table update unit 105 generates a recommended measure plan by using, for example, the measure related information 130. The table update unit 105 compares the measure planned by the measure calculation unit 102 with the recommended measure plan. The table update unit 105 increases or decreases the value of the priority in the measure compatibility table 121 based on the comparison result.

For example, the table update unit 105 may increase the priority of a combination of measures having a low overlapping rate of threats that can be dealt with or the effects of the measures. In addition, the table update unit 105 may increase the priority of a combination of measures having a low overlapping rate of functions. The table update unit 105 may decrease the priority of a combination of measures having a high overlapping rate. The table update unit 105 may increase the priority of a combination of measures that frequently appear in measures implemented in the past. The table update unit 105 may increase the priority of a combination of measures using a product that is discounted when purchased simultaneously. When a failure occurs in a case where specific measures are combined, the table update unit 105 may decrease the priority of the combination.

The measure effect visualization unit 104 calculates the effects (priorities) of the measures included in the planned measure and a combination thereof for each attack route (step B7). In this example embodiment, the measure effect visualization unit 104 can calculate the sum total of the priorities of the measures included in the planned measure and the priorities of the combinations of measures included in the planned measure as the effect of the measure. The measure effect visualization unit 104 displays the calculated effect of the measure in association with the risk value of the attack route (step B8). The steps B1, B2, B7, and B8 may be similar to the steps A1, A2, A6, and A7 shown in FIG. 6.

In this example embodiment, the measure compatibility table 121 holds information about, for example, the effects or the priorities of measures and whether or not combinations are possible for specific combinations of measures. In this example embodiment, by using the measure compatibility table 121, the measure calculation unit 102 can plan a measure in which a plurality of measures are combined in consideration of a synergistic effect under the assumption that the plurality of measures are combined and overlapping of the effects of the measures. In addition, in this example embodiment, the table update unit 105 updates the measure compatibility table 121 by using the measure related information 130. In this example embodiment, even in a case where the security operator does not have specialized advanced security knowledge, it is possible to obtain the measure compatibility table 121 that enables planning of a measure in which appropriate measures are combined. The measure planning support apparatus 100a according to this example embodiment updates the measure compatibility table 121 by using the measure related information 130, so that a measure in which a plurality of measures are combined can be appropriately planned.

Next, a third example embodiment will be described. FIG. 12 shows an information processing apparatus according to a third example embodiment of the present disclosure. A configuration of an information processing apparatus (measure planning support apparatus) 100b according to this example embodiment may be similar to the configuration of the measure planning support apparatus 100a shown in FIG. 7. In this example embodiment, an operator (user) can modify a measure planned by a measure calculation unit 102, that is, a measure plan presented by the measure planning support apparatus 100b by referring to information output by a measure effect visualization unit 104. In this example embodiment, measure related information 130 includes information regarding modification of a measure plan.

Although the measure plan presented by the measure planning support apparatus 100b is a recommended measure, it may be impossible to introduce the measure plan in actual operation. For example, when introducing the presented measure plan into the system, the user can modify the measure plan. When modifying the measure plan, the user can record, as modification information, whether or not to adopt the measure plan and each measure included in the modified measure plan (modified measure plan), and reasons therefor in the measure related information 130.

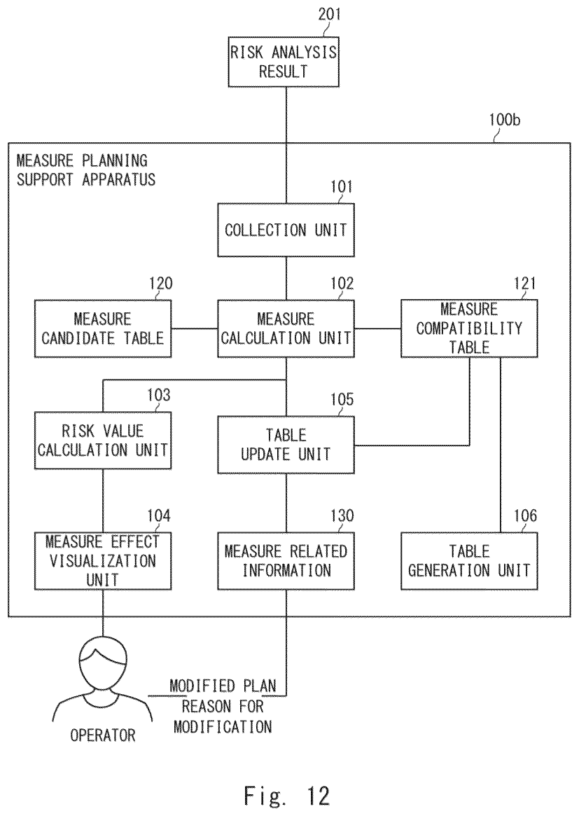

FIG. 13 shows an example of the modification information recorded in the measure related information 130. For example, it is assumed that the measure plan includes a measure A, a measure B, and a measure C. It is assumed that the user makes a modification to replace the measure C with a measure D in the measure plan. In this case, the user records “Adopted” for the measure A, the measure B, and the measure D, and records “Not adopted” for the measure C in the measure related information 130. In addition, the user records “High cost” in the measure related information 130 as a reason for not adopting the measure C, and records “Alternative plan for measure C” in the measure related information 130 as a reason for adopting the measure D.

In this example embodiment, a table update unit 105 updates a priority in a measure compatibility table 121 by using the presented measure plan and the modification information recorded in the measure related information 130. For example, the table update unit 105 increases or decreases the priorities of a combination of measures including a measure that is included in the presented measure plan and is not included in the modified measure plan, and a combination of measures including a measure that is included in the modified measure plan and is not included in the presented measure plan. For example, the table update unit 105 decreases the priority of a combination of measures including a measure that is included in the presented measure plan and is not included in the modified measure plan, that is, a measure deleted from the measure plan. The table update unit 105 increases the priority of a combination of measures including a measure that is included in the modified measure plan and is not included in the presented measure plan, that is, a measure added by the modification.

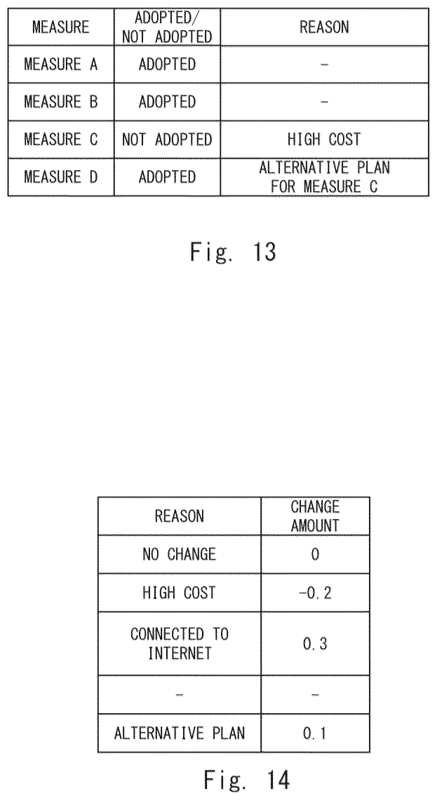

FIG. 14 shows an example of a table used to update the measure compatibility table 121. The table shown in FIG. 14 defines the reason for the modification and a change amount in the update of the priority. The table update unit 105 increases or decreases the priority of the measure compatibility table 121 by the change amount corresponding to the reason for the modification by referring to the table that defines the change amount shown in FIG. 14. The table update unit 105 does not change a value of the priority since the change amount is “0” for a measure having no change between the presented measure plan and the changed measure plan. When the reason for the modification is “High cost”, the change amount is “−0.2”, and thus the table update unit 105 decreases the value of the priority by 0.2. When the reason for the modification is “Alternative plan”, the change amount is “0.1”, and thus the table update unit 105 increases the value of the priority by 0.1.

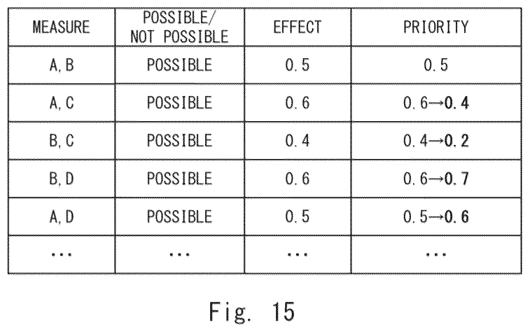

FIG. 15 shows an example of the update of the measure compatibility table. The table update unit 105 extracts a combination including the measure D added in the modified measure plan in the measure compatibility table 121. In FIG. 15, the measure compatibility table 121 includes a combination of the measure A and the measure D and a combination of the measure B and the measure D as the combinations including the measure D. Since the reason for the modification of the measure D is “Alternative plan”, the table update unit 105 increases the priority of the combination of the measure A and the measure D and the priority of the combination of the measure B and the measure D by 0.1.

In addition, the table update unit 105 extracts a combination including the measure C deleted in the modified measure plan in the measure compatibility table 121. In FIG. 15, the measure compatibility table 121 includes the combination of the measure A and the measure C and a combination of the measure B and the measure C as the combinations including the measure C. Since the reason for the modification of the measure C is “High cost”, the table update unit 105 decreases the priority of the combination of the measure A and the measure C and the priority of the combination of the measure B and the measure C by 0.2.

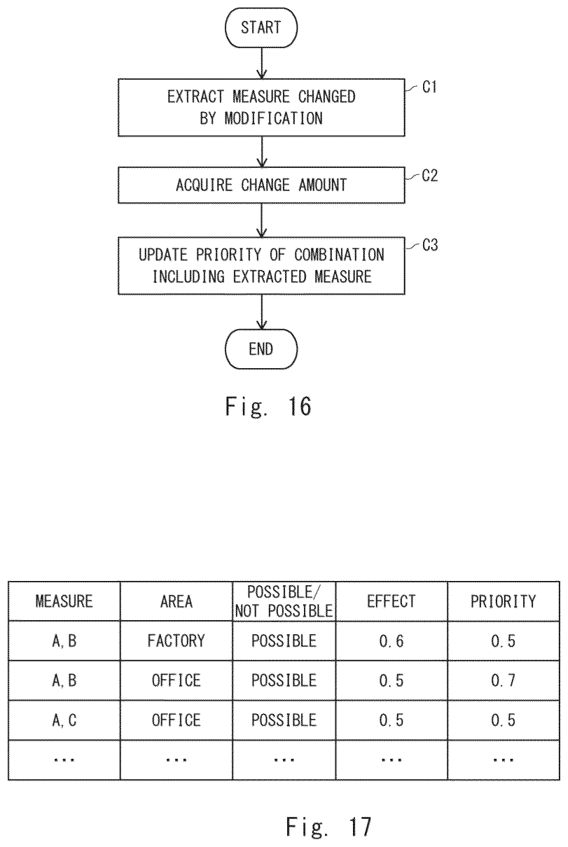

Next, a procedure of updating the measure compatibility table in this example embodiment will be described. FIG. 16 shows an operating procedure performed by the table update unit 105. The table update unit 105 extracts a measure changed by the modification based on the measure related information 130 and the measure planned by the measure calculation unit 102 (step C1). The table update unit 105 acquires the change amount under the assumption that the priority is updated based on the reason for the modification (step C2). In the step C2, the table update unit 105 acquires the change amount corresponding to the reason for the modification from, for example, the table shown in FIG. 14.

The table update unit 105 updates the priority of a combination of measures including the measure extracted in the step C1 included in the measure compatibility table 121 by using the change amount acquired in the step C2 (step C3). In the step C3, for example, the table update unit 105 decreases the priority of a combination including a measure deleted by the modification by a value corresponding to the reason for the modification. In addition, for example, the table update unit 105 increases the priority of a combination including a measure that has not been present before the modification by a value corresponding to the reason for the modification.

In this example embodiment, the table update unit 105 updates the measure compatibility table 121 according to a modification made by the operator using the measure related information 130. For example, the table update unit 105 sets a measure plan modified by the operator as a correct measure plan, and compares the correct measure plan with the measure planned by the measure calculation unit 102. The table update unit 105 updates the measure compatibility table 121 based on the comparison result. The measure calculation unit 102 can plan a measure close to the measure plan modified by a person who has made the modification by planning a measure using the updated measure compatibility table 121 in the planning of next or subsequent measures.

In the second and third example embodiments described above, an example in which the table update unit 105 updates the measure compatibility table 121 has been described. However, the present disclosure is not limited thereto. In the second and third example embodiments, the table update unit 105 may update the priority of the measure candidate table 120.

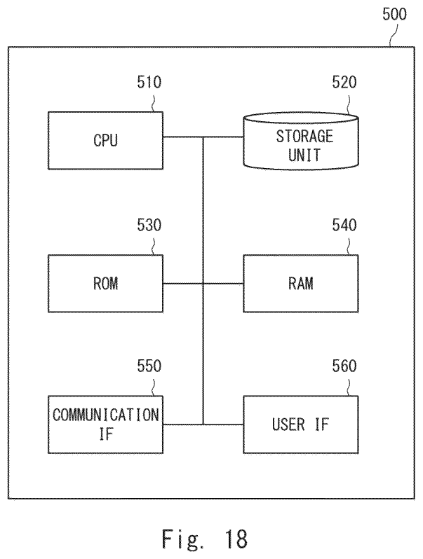

Note that it is considered that depending on an area where the system to be analyzed is installed and the type of the system to be analyzed, measures that can be introduced, combinations of measures that can be introduced, the effects of measures, and priorities of measures may change. At least one of the measure candidate table 120 and the measure compatibility table 121 may hold such information for each condition of the system. FIG. 17 shows another example of the measure compatibility table 121. In this example, the measure compatibility table 121 includes areas of the system to be analyzed. The measure compatibility table 121 holds effects of combinations of measures, priorities, and whether combinations are possible or not for a case where the system to be analyzed is the system of a “Factory”. Further, the measure compatibility table 121 holds effects of combinations of measures, priorities, and whether combinations are possible or not for a case where the system to be analyzed is the system of an “Office”. As shown in this example, the measure compatibility table 121 may hold information defined for each area.

In the above case, the measure related information 130 may include information about applicable conditions (areas) of the system. The table update unit 105 may update the priority corresponding to the area of the system to be analyzed in the measure compatibility table 121 by using the measure related information 130 applicable to the area of the system to be analyzed. Furthermore, when the measure compatibility table 121 has information as to whether combinations are possible or not for each area, the measure calculation unit 102 refers to information corresponding to the area of the system to be analyzed and thereby checks whether the above-described combination is contained in the measure compatibility table 121

In each example embodiment described above, the measure candidate table 120 and the measure compatibility table 121 do not necessarily have to be included in the measure planning support apparatus 100 as long as it can be accessed from the measure planning support apparatus 100. For example, at least one of the measure candidate table 120 and the measure compatibility table 121 may be disposed on a cloud system, and the measure planning support apparatus 100 may access the measure candidate table 120 and the measure compatibility table 121 disposed on the cloud system through a network

Next, a physical configuration of the measure planning support apparatus 100 will be described. FIG. 18 shows an example of a configuration of a computer apparatus that can be used as the measure planning support apparatus 100. A computer apparatus 500 includes a control unit (central processing unit (CPU)) 510, a storage unit 520, a read only memory (ROM) 530, a random access memory (RAM) 540, a communication interface (IF) 550, and a user interface (IF) 560.

The communication interface 550 is an interface for connecting the computer apparatus 500 to a communication network through wired communication means or wireless communication means or the like. The user interface 560 includes, for example, a display unit such as a display device. Further, the user interface 560 includes an input unit such as a keyboard, a mouse, and a touch panel.

The storage unit 520 is an auxiliary storage device that can hold various types of data. The storage unit 520 does not necessarily have to be a part of the computer apparatus 500, but may be an external storage device, or a cloud storage connected to the computer apparatus 500 through a network. The storage unit 520 can be used to store, for example, at least one of the measure candidate table 120 and the measure compatibility table 121 shown in FIG. 7.

The ROM 530 is a non-volatile storage device. For example, a semiconductor storage device such as a flash memory having a relatively small capacity can be used for the ROM 530. A program(s) that is executed by the CPU 510 may be stored in the storage unit 520 or the ROM 530. The storage unit 520 or the ROM 530 stores, for example, various programs for implementing the function of each unit in the measure planning support apparatus 100.

The program includes a set of instructions (or software codes) that, when read into a computer, causes the computer to perform one or more of the functions described in the example embodiments. The program may be stored in a non-transitory computer readable medium or in a physical storage medium. By way of example rather than limitation, a computer readable medium or a physical storage medium may include a RAM, a ROM, a flash memory, a solid-state drive (SSD), or other memory technology, a Compact Disc (CD), a digital versatile disc (DVD), Blu-ray (Registered Trademark) disc or other optical disc storages, a magnetic cassette, magnetic tape, and a magnetic disc storage or other magnetic storage devices. The program may be transmitted on a transitory computer readable medium or a communication medium. By way of example rather than limitation, the transitory computer readable medium or the communication medium may include electrical, optical, acoustic, or other forms of propagating signals.

The RAM 540 is a volatile storage device. As the RAM 540, various types of semiconductor memory apparatuses such as a dynamic random access memory (DRAM) or a static random access memory (SRAM) can be used. The RAM 540 can be used as an internal buffer for temporarily storing data and the like. The CPU 510 loads a program stored in the storage unit 520 or the ROM 530 in the RAM 540, and executes the loaded program. The function of each unit in the measure planning support apparatus 100 can be implemented by the CPU 510 executing a program. The CPU 510 may include an internal buffer in which data or the like can be transitorily stored.

Note that the measure planning support apparatus 100 does not necessarily have to be physically configured as one apparatus, and may be configured using a plurality of apparatuses. For example, in the measure planning support apparatus 100, an apparatus including the measure calculation unit 102 and an apparatus including the table update unit 105 may be separately provided. Alternatively, in the measure planning support apparatus 100, an apparatus including the table generation unit 106 and an apparatus including the table update unit 105 may be separately provided.

Although example embodiments according to the present disclosure have been described above in detail, the present disclosure is not limited to the above-described example embodiments, and the present disclosure also includes those that are obtained by making changes or modifications to the above-described example embodiments without departing from the scope of the present disclosure.

The whole or part of the example embodiments disclosed above can be described as, but not limited to, the following Supplementary notes.

### Supplementary Note 1

An information processing apparatus including:
analysis result acquisition means for acquiring a result of a risk analysis on a system to be analyzed, including an attack route;
measure calculation means for planning a measure against an attack used in the attack route by using a measure information table including an index indicating an effect of the measure introduced against the attack; and
table update means for updating the index indicating the effect included in the measure information table based on the planned measure and measure related information.

### Supplementary Note 2

The information processing apparatus described in Supplementary note 1, wherein the measure related information includes at least one of a measure policy for constructing a robust system, a measure policy according to a predetermined security policy, and a measure policy for using a specific measure product.

### Supplementary Note 3

The information processing apparatus described in Supplementary note 1 or 2, wherein the measure information table includes a measure candidate table containing a plurality of measures introducible against the attack and an index indicating an effect of each measure.

### Supplementary Note 4

The information processing apparatus described in Supplementary note 3, wherein the table update means compares a measure planned according to the measure related information with a measure included in the planned measure, and updates the measure candidate table based on a result of the comparison.

### Supplementary Note 5

The information processing apparatus described in Supplementary note 3 or 4, wherein
the measure information table further includes a measure compatibility table containing a combination of measures in which two or more of the plurality of measures are combined and an index indicating an effect of the combination of measures, and
the measure calculation means plans a measure including a plurality of measures by using the measure candidate table and the measure compatibility table.

### Supplementary Note 6

The information processing apparatus described in Supplementary note 5, wherein the table update means compares a combination of measures included in the measure planned according to the measure related information with a combination of measures included in the planned measure, and updates the measure compatibility table based on a result of the comparison.

### Supplementary Note 7

The information processing apparatus described in Supplementary note 5 or 6, further including table generation means for generating the measure compatibility table based on a plurality of pieces of measure related information that have been input by using the plurality of pieces of measure related information as inputs.

### Supplementary Note 8

The information processing apparatus described in Supplementary note 7, wherein the table generation means includes:
initialization means for initializing the index indicating the effect of the combination of measures contained in the measure compatibility table; and
table value update means for updating the index indicating the effect of the combination of measures contained in the measure compatibility table according to whether or not the combination of measures contained in the measure compatibility table is included in a measure planned according to a measure policy included in the measure related information.

### Supplementary Note 9

The information processing apparatus described in any one of Supplementary notes 5 to 8, wherein
the measure related information includes, in a case where a modification is made to the planned measure, information regarding the modification, and
the table update means updates the index indicating the effect of the combination of measures contained in the measure compatibility table based on the planned measure and the information regarding the modification.

### Supplementary Note 10

The information processing apparatus described in Supplementary note 9, wherein the table update means increases or decreases a value of the index indicating the effect of the combination of measures for the combination of measures including a measure that is included in the planned measure and is not included in the modified measure and the combination of measures including a measure that is included in the modified measure and is not included in the planned measure.

### Supplementary Note 11

The information processing apparatus described in Supplementary note 10, wherein
the measure related information includes a reason for the modification, and
the table update means increases or decreases the value of the index indicating the effect of the combination of measures by a change amount corresponding to the reason for the correction.

### Supplementary Note 12

The information processing apparatus described in any one of Supplementary notes 1 to 11, further including:
risk value calculation means for calculating a risk value of the attack route under an assumption that the planned measure is introduced into the system to be analyzed based on the measure information table; and
measure effect visualization means for calculating the effect of the measure under an assumption that the planned measure is introduced for each attack route, and displaying the calculated effect of the measure in association with the risk value of the attack route.

### Supplementary Note 13

The information processing apparatus described in any one of Supplementary notes 1 to 12, wherein the index indicating the effect of the measure is set according to the effect of the measure and an introduction cost of the measure.

### Supplementary Note 14

An information processing method including:
acquiring a result of a risk analysis on a system to be analyzed, including an attack route;
planning a measure against an attack used in the attack route by using a measure information table including an index indicating an effect of the measure introduced against the attack; and
updating the index indicating the effect included in the measure information table based on the planned measure and measure related information.

### Supplementary Note 15

A non-transitory computer readable medium storing a program for causing a computer to perform processes including:
acquiring a result of a risk analysis on a system to be analyzed, including an attack route;
planning a measure against an attack used in the attack route by using a measure information table including an index indicating an effect of the measure introduced against the attack; and
updating the index indicating the effect included in the measure information table based on the planned measure and measure related information.

### REFERENCE SIGNS LIST

10 INFORMATION PROCESSING APPARATUS
11 ANALYSIS RESULT ACQUISITION MEANS
12 MEASURE CALCULATION MEANS
13 TABLE UPDATE MEANS
15 MEASURE INFORMATION TABLE
16 MEASURE RELATED INFORMATION
100 MEASURE PLANNING SUPPORT APPARATUS
101 COLLECTION UNIT
102 MEASURE CALCULATION UNIT
103 RISK VALUE CALCULATION UNIT
104 MEASURE EFFECT VISUALIZATION UNIT
105 TABLE UPDATE UNIT
106 TABLE GENERATION UNIT
120 MEASURE CANDIDATE TABLE
121 MEASURE COMPATIBILITY TABLE
161 TABLE INITIALIZATION UNIT
162 TABLE VALUE UPDATE UNIT
201 RISK ANALYSIS RESULT
500 COMPUTER APPARATUS
510 CPU
520 STORAGE UNIT
530 ROM
540 RAM
550 COMMUNICATION IF
560 USER IF

What is claimed is:

1. An information processing apparatus comprising:
at least one memory storing instructions; and
at least one processor configured to execute the instructions to:
acquire a result of a risk analysis on a system to be analyzed, including an attack route;
plan a measure against an attack used in the attack route by using a measure information table including an index indicating an effect of the measure introduced against the attack; and
update the index indicating the effect included in the measure information table based on the planned measure and measure related information.

2. The information processing apparatus according to claim 1, wherein the measure related information includes at least one of a measure policy for constructing a robust system, a measure policy according to a predetermined security policy, and a measure policy for using a specific measure product.

3. The information processing apparatus according to claim 1, wherein the measure information table includes a measure candidate table containing a plurality of measures introducible against the attack and an index indicating an effect of each measure.

4. The information processing apparatus according to claim 3, wherein the at least one processer is configured to execute the instructions to compare a measure planned according to the measure related information with a measure included in the planned measure, and update the measure candidate table based on a result of the comparison.

5. The information processing apparatus according to claim 3, wherein
the measure information table further includes a measure compatibility table containing a combination of measures in which two or more of the plurality of measures are combined and an index indicating an effect of the combination of measures, and
the at least one processer is configured to execute the instructions to plan a measure including a plurality of measures by using the measure candidate table and the measure compatibility table.

6. The information processing apparatus according to claim 5, wherein the at least one processer is configured to execute the instructions to compare a combination of measures included in the measure planned according to the measure related information with a combination of measures included in the planned measure, and update the measure compatibility table based on a result of the comparison.

7. The information processing apparatus according to claim 5, wherein the at least one processer is configured to execute the instructions to generate the measure compatibility table based on a plurality of pieces of measure related information that have been input by using the plurality of pieces of measure related information as inputs.

8. The information processing apparatus according to claim 7, wherein the at least one processer is configured to execute the instructions to:
initialize the index indicating the effect of the combination of measures contained in the measure compatibility table; and
update the index indicating the effect of the combination of measures contained in the measure compatibility table according to whether or not the combination of measures contained in the measure compatibility table is included in a measure planned according to a measure policy included in the measure related information.

9. The information processing apparatus according to claim 5, wherein
the measure related information includes, in a case where a modification is made to the planned measure, information regarding the modification, and
the at least one processer is configured to execute the instructions to update the index indicating the effect of the combination of measures contained in the measure compatibility table based on the planned measure and the information regarding the modification.

10. The information processing apparatus according to claim 9, wherein the at least one processer is configured to execute the instructions to increase or decrease a value of the index indicating the effect of the combination of measures for the combination of measures including a measure that is included in the planned measure and is not included in the modified measure and the combination of measures including a measure that is included in the modified measure and is not included in the planned measure.

11. The information processing apparatus according to claim 10, wherein
the measure related information includes a reason for the modification, and
the at least one processer is configured to execute the instructions to increase or decrease the value of the index indicating the effect of the combination of measures by a change amount corresponding to the reason for the correction.

12. The information processing apparatus according to claim 1, wherein the at least one processer is configured to execute the instructions to:
calculate a risk value of the attack route under an assumption that the planned measure is introduced into the system to be analyzed based on the measure information table; and
calculate the effect of the measure under an assumption that the planned measure is introduced for each attack route, and display the calculated effect of the measure in association with the risk value of the attack route.

13. The information processing apparatus according to claim 1, wherein the index indicating the effect of the measure is set according to the effect of the measure and an introduction cost of the measure.

14. An information processing method comprising:
acquiring a result of a risk analysis on a system to be analyzed, including an attack route;
planning a measure against an attack used in the attack route by using a measure information table including an index indicating an effect of the measure introduced against the attack; and
updating the index indicating the effect included in the measure information table based on the planned measure and measure related information.

15. A non-transitory computer readable medium storing a program for causing a computer to perform processes including:
acquiring a result of a risk analysis on a system to be analyzed, including an attack route;
planning a measure against an attack used in the attack route by using a measure information table including an index indicating an effect of the measure introduced against the attack; and
updating the index indicating the effect included in the measure information table based on the planned measure and measure related information.
